(19) United States
(12) Patent Application Publication
(10) Pub. No.: US 2025/0004356 A1
(43) Pub. Date: Jan. 2, 2025

(54) DISPLAY DEVICE

(71) Applicant: Sharp NEC Display Solutions, Ltd., Tokyo (JP)

(72) Inventor: Ryosuke KAWASE, Tokyo (JP)

(21) Appl. No.: 18/884,759

(22) Filed: Sep. 13, 2024

Related U.S. Application Data
(63) Continuation of application No. PCT/JP2022/014187, filed on Mar. 24, 2022.

(51) Int. Cl. G03B 21/16

(52) U.S. Cl. CPC G03B 21/16

(57) ABSTRACT

A display device includes a light source; and an optical engine configured to generate image light to be displayed on a display surface on the basis of light from the light source. The display device further includes a power supply board configured to drive the light source and the optical engine. The display device further includes a case configured to accommodate a device component which comprises at least one of the optical engine and the power supply board. The case has a wall which include a heat radiating part that is thermally connected to a heat generating component included in the device component, to allow heat of the heat generating component to be released outside of the case. The heat generating component is mounted on a first surface of a board included in the device component.

### TECHNICAL FIELD

The present disclosure relates to a display device.

### BACKGROUND ART

In the related art, there are display devices that modulate light emitted from a light source using an optical modulation element such as a digital micromirror device (DMD) or an LCD panel and display modulated image light on a display surface. For example, display devices include projection-type display devices that enlarge and project modulated image light onto a screen serving as a display surface using a projection lens. Such display devices have a constitution in which a light source, an optical component such as an optical modulation element, an optical engine including electronic components, and a power supply board for driving the light source and the optical engine are provided inside a predetermined housing.

In optical engines, temperature rise in optical components due to strong light incident on the optical components from a light source and heat generation in electronic components due to an electrical resistance occur. A permissible temperature (upper-limit temperature) for exhibiting desired performance is set for each of the optical components and the electronic components. For this reason, in optical engines, there is a need for optical components and electronic components to be cooled.

A power supply board has a constitution in which various kinds of power supply components are mounted on a wiring board. Since power supply components generate a large amount of heat due to their electrical resistance, there is a need for them to be cooled similar to the electronic components described above.

Patent Document 1 discloses a heat dissipation structure in which upper end surfaces of a plurality of heat dissipation plates fixed to respective heat generating component are positioned at the same height on the corresponding heat generating component and which is equipped with one radiator (heat sink) on the upper end surfaces of the plurality of heat dissipation plates in order to effectively dissipate heat of the plurality of heat generating component mounted on a board.

### CITATION LIST

### Patent Document

### [Patent Document 1]

Japanese Unexamined Patent Application, First Publication No. 2018-148125

### SUMMARY OF INVENTION

### Technical Problem

Incidentally, for the purpose of preventing degradation in luminance of image light due to dust and a short circuit of a circuit including electronic components and power supply components due to dust, display devices are required to prevent dust from adhering to optical components and electronic components of an optical engine and power supply components on a power supply board. For this reason, it is conceivable that an optical engine and a power supply board (which will hereinafter be referred to as “device components”) be accommodated in a case which is sealed or has a high sealing degree.

A circulation cooling method can be considered as a method for cooling heat generating component (optical components, electronic components, power supply components, and the like described above) of the device components accommodated in a case. In the circulation cooling method, a radiator, such as a heat sink or a heat pipe, and a cooling fan are provided inside the case. Further, a circulation flow of air is made inside the case by the fan, and heat exchange is performed between the heat generating component and the radiator through the air flowing inside the case. Moreover, the heat generating component are cooled by the radiator discharging heat outside of the case.

However, in the circulation cooling method, since there is a need to install a radiator and a fan inside a case, there is a problem that the number of components of a display device increases. In addition, since the size of a case increases, there is also a problem that it leads to increase in size of a display device.

This invention has been made in consideration of the circumstances described above, and an object thereof is to provide a display device that can efficiently release heat of heat generating component of device components outside of a case without increasing the number of components of the display device while increase in size of the display device is curbed even if the device components are disposed inside the case.

### Solution to Problem

An aspect of the present invention is a display device including a light source, an optical engine generating image light displayed on a display surface on the basis of light from the light source, a power supply board for driving the light source and the optical engine, and a case accommodating at least one of device components such as the optical engine and the power supply board. A wall of the case includes a heat radiating part thermally connected to heat generating component included in the device component so as to release heat of the heat generating component outside of the case. The heat generating component are mounted on a first surface of a board included in the device component.

### Advantageous Effects of Invention

According to the present invention, it is possible to efficiently release heat of heat generating component of device components outside of a case without increasing the number of components while increase in size of the display device is curbed even if the device components are disposed inside the case.

### BRIEF DESCRIPTION OF DRAWINGS

FIG. 1 is a perspective view showing an external appearance of a display device according to a first embodiment of the present invention.

FIG. 2 is a planar cross-sectional view showing a layout of the inside of a housing of the display device in FIG. 1.

FIG. 3 is a perspective view showing a case accommodating a power supply board in the display device in FIGS. 1 and 2.

FIG. 4 is an exploded perspective view of FIG. 3.

FIG. 5 is a side view showing the power supply board in FIG. 4.

FIG. 6 is a perspective view showing a state in which the power supply board in FIG. 4 is placed in a lower wall of the housing.

FIG. 7 is a perspective view showing a case accommodating an optical engine in the display device according to a second embodiment of the present invention.

FIG. 8 is an exploded perspective view of FIG. 7.

FIG. 9 is a cross-sectional view showing the optical engine and the case in FIGS. 7 and 8.

FIG. 10 is a cross-sectional view schematically showing a modification example of the display device of the first embodiment.

### DESCRIPTION OF EMBODIMENTS

### First Embodiment

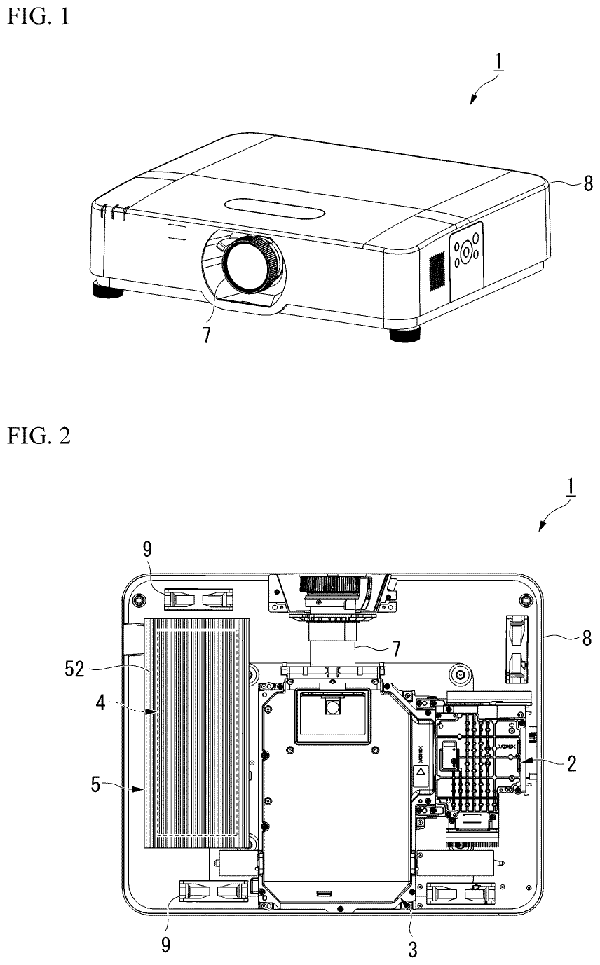

Hereinafter, a first embodiment of the present invention will be described with reference to FIGS. 1 to 6.

A display device 1 shown in FIG. 1 is a device displaying image light (video image) on a display surface. Specifically, the display device 1 of the present embodiment is a projection-type display device (projector) projecting image light onto a screen serving as a display surface. The display device 1 shown in FIGS. 1 and 2 includes a light source 2, an optical engine 3, a power supply board 4, and a case 5. In addition, the display device 1 of the present embodiment further includes a projection lens 7 and a housing 8. The housing 8 accommodates the light source 2, the optical engine 3, the power supply board 4, the case 5, and the like.

The light source 2 emits light toward the optical engine 3 which will be described below. For example, the light source 2 may be a lamp, a laser, a light emitting diode (LED), or the like.

The optical engine 3 generates image light on the basis of light from the light source 2. Although it is not illustrated, the optical engine 3 has optical components and electronic components. For example, the optical components may be optical modulation elements such as digital micromirror devices (DMDs) or LCD panels. The electronic components control the optical components. The optical components and the electronic components are driven by means of power supplied from the power supply board 4 which will be described below.

The projection lens 7 is a lens magnifying image light made by the optical engine 3. Accordingly, in the display device 1 of the present embodiment, image light made by the optical engine 3 can be projected onto a screen after being magnified by the projection lens 7.

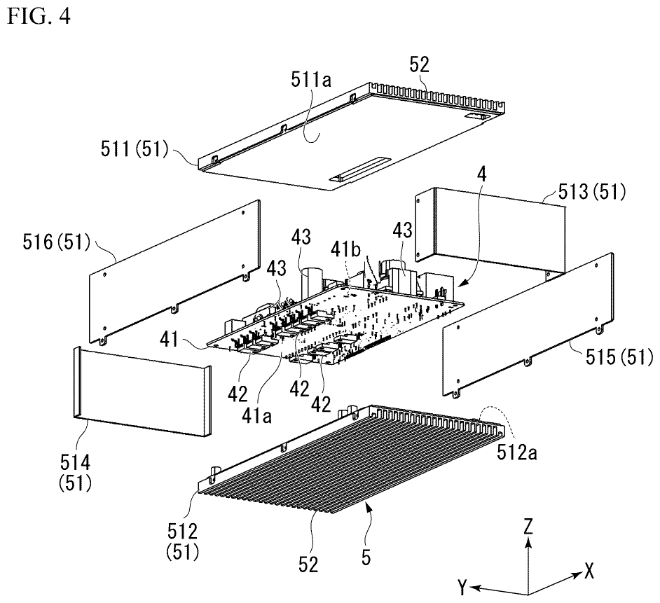

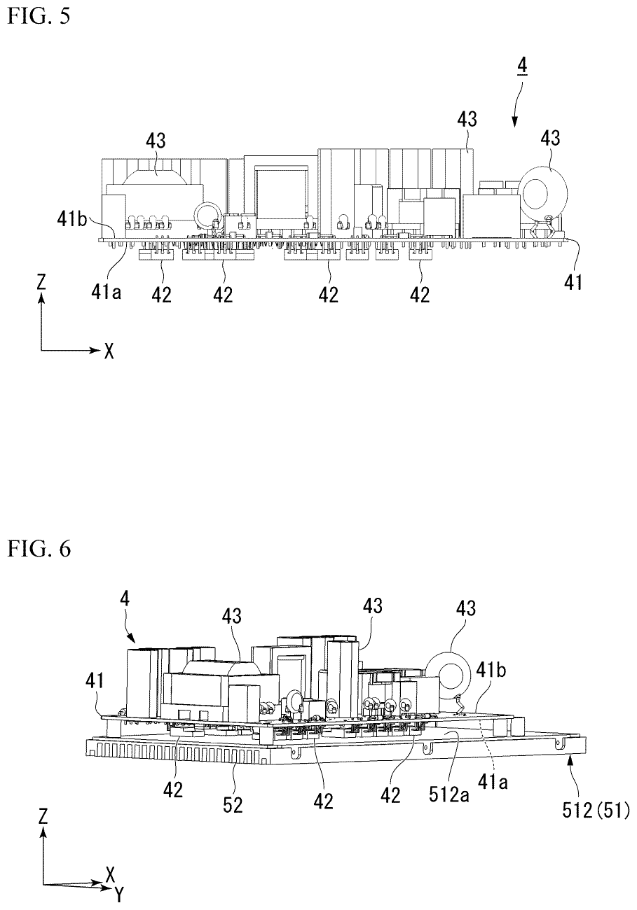

The power supply board 4 mainly supplies power to the light source 2 and the optical engine 3 so as to drive the light source 2 and the optical engine 3. As shown in FIGS. 4 and 5, the power supply board 4 (device component) has a board 41 (wiring board) and a plurality of power supply components 42 and 43 mounted on the board 41. Both the plurality of power supply components 42 and 43 are heat generating component generating heat through electrification. The plurality of power supply components 42 and 43 include a plurality of first power supply components 42 whose temperature is likely to rise due to heat generation through electrification, and a plurality of second power supply components 43 whose temperature rise due to heat generation is smaller than that of the first power supply components 42.

The plurality of first power supply components 42 are mounted on only a first surface 41a of the board 41. In a state of being mounted on the first surface 41a of the board 41, heights of the plurality of first power supply components 42 with respect to the first surface 41a are made uniform.

The plurality of second power supply components 43 are mounted on only a second surface 41b of the board 41 facing a side opposite to the first surface 41a. In a state of being mounted on the second surface 41b of the board 41, heights of the plurality of second power supply components 43 with respect to the second surface 41b are not uniform.

The case 5 shown in FIGS. 2 to 4 accommodates the foregoing power supply board 4 (device component) in a sealed state with respect to the outside or a state with a high sealing degree. The sealing degree of the case 5 may be a sealing degree to the extent that neither air nor dust circulates between the inside and the outside of the case 5 or a sealing degree to the extent that air can circulate but dust is not able to circulate between the inside and the outside of the case 5. Walls 51 of the case 5 are thermally connected to the power supply components 42 and 43 (heat generating component) of the power supply board 4. Hereinafter, the case 5 of the present embodiment will be specifically described.

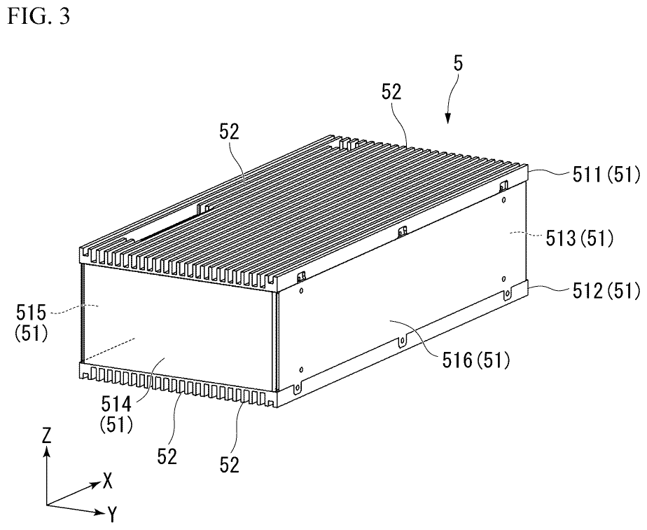

The case 5 of the present embodiment shown in FIG. 3 has a rectangular parallelepiped external appearance and has six flat plate-shaped walls 51 which are directed forward, rearward, leftward, rightward, upward, and downward respectively. In FIGS. 3 to 6, an X axis direction indicates a forward-rearward direction, and a Y axis direction indicates a lateral direction. In addition, a Z axis direction indicates a vertical direction. Two walls 51 of the case 5 arranged in the vertical direction are constituted of an upper wall 511 and a lower wall 512. Two walls 51 of the case 5 arranged in the forward-rearward direction are constituted of a front wall 513 and a rear wall 514. Two walls 51 of the case 5 arranged in the lateral direction are constituted of a left wall 515 and a right wall 516.

The six walls 51 shown in FIGS. 3 and 4 each include a heat radiating part which releases heat of the power supply components 42 and 43 outside of the case 5. It is preferable that the six walls 51 serving as heat radiating parts be formed of a material having a high heat conductivity, such as aluminum. When the case 5 is constituted by assembling the six walls 51, in order to prevent inflow of dust, it is preferable to use a cushion or a gasket (made of a soft metal or the like, such as rubber or copper) between adjacent walls 51.

As shown in FIGS. 4 and 6, the lower wall 512 of the case 5 is disposed in a manner of facing the first surface 41a (lower surface) of the board 41 constituting the power supply board 4. Further, the plurality of first power supply components 42 mounted on the first surface 41a of the board 41 are thermally connected to an inner surface 512a of the lower wall 512. In the present embodiment, the plurality of first power supply components 42 are thermally connected to the lower wall 512 with no air therebetween.

As described above, the heights of the plurality of first power supply components 42 with respect to the first surface 41a of the board 41 are made uniform. For this reason, for example, as shown in FIG. 6, the plurality of first power supply components 42 directly come into contact with the flat inner surface 512a of the lower wall 512 so that they can be thermally connected to the lower wall 512 with no air therebetween. When there is a need to electrically insulate the first power supply components 42 and the lower wall 512 (the case 5) from each other, an insulating sheet or the like may be interposed between the first power supply components 42 and the lower wall 512 (the case 5).

As shown in FIG. 4, the upper wall 511 of the case 5 is disposed in a manner of facing the second surface 41b (upper surface) of the board 41 constituting the power supply board 4. Further, the plurality of second power supply components 43 mounted on the second surface 41b of the board 41 are thermally connected to an inner surface 511a of the upper wall 511. In the present embodiment, the plurality of second power supply components 43 are thermally connected to the upper wall 511 through the air.

Respective inner surfaces of the front wall 513, the rear wall 514, the left wall 515, and the right wall 516 of the case 5 surround the board 41 of the power supply board 4 accommodated in the case 5. The respective inner surfaces of the front wall 513, the rear wall 514, the left wall 515, and the right wall 516 are disposed with an interval with respect to the plurality of power supply components 42 and 43 mounted on the board 41. For this reason, the plurality of power supply components 42 and 43 are thermally connected to the front wall 513, the rear wall 514, the left wall 515, and the right wall 516 through the air.

As shown in FIGS. 3 and 4, a plurality of heat radiator fins 52 are provided on outer surfaces of the upper wall 511 and the lower wall 512 of the case 5. Each of the plurality of heat radiator fins 52 extends in one direction along the outer surfaces of the upper wall 511 and the lower wall 512. The plurality of heat radiator fins 52 are arranged with an interval therebetween in a direction orthogonal to the one direction along the outer surfaces of the upper wall 511 and the lower wall 512. In FIGS. 3 and 4, each of the heat radiator fins 52 extends in the forward-rearward direction, and the plurality of heat radiator fins 52 are arranged with an interval therebetween in the lateral direction.

As shown in FIG. 2, the case 5 accommodating the power supply board 4 is accommodated inside the housing 8. A fan 9 for cooling the case 5 is provided inside the housing 8. The fan 9 causes air to flow outside the case 5. The walls 51 of the case 5 are cooled through heat exchange between air flowing outside the case 5 by the fan 9 and the walls 51 of the case 5.

In the present embodiment, the fan 9 is disposed such that air flows in a direction in which the heat radiator fins 52 provided in the case 5 extend. Accordingly, heat exchange can be efficiently performed between air flowing inside the housing 8 and the case 5. That is, the walls 51 of the case 5 can be efficiently cooled.

As described above, in the display device 1 of the present embodiment, the walls 51 of the case 5 accommodating the power supply board 4 (device component) are thermally connected to the power supply components 42 and 43 (heat generating component) of the power supply board 4. That is, the walls 51 of the case 5 have both a function of preventing dust from adhering to the power supply board 4 and a function of dissipating heat of the power supply components 42 and 43 outside of the case 5. For this reason, even if a heat dissipation component (a radiator or a fan) for the power supply components 42 and 43 is not separately installed inside the case 5, heat of the power supply components 42 and 43 can be efficiently dissipated outside of the case 5. Accordingly, increase in number of constituent components of the display device 1 can be curbed, and increase in size of the case 5 can also be curbed. Therefore, heat of the power supply components 42 and 43 can be efficiently released outside of the case 5 without increasing the number of components of the display device 1 while increase in size of the display device 1 is curbed even if the power supply board 4 is disposed inside the case 5.

In addition, in the display device 1 of the present embodiment, the plurality of first power supply components 42 are mounted on the first surface 41a of the board 41 constituting the power supply board 4. Further, the plurality of first power supply components 42 are thermally connected to the inner surface 512a of the lower wall 512 of the case 5 facing the first surface 41a of the board 41. Accordingly, by simply causing the first surface 41a of the board 41 to face the inner surface 512a of the lower wall 512 of the case 5, the plurality of first power supply components 42 can be simply thermally connected to the inner surface 512a of the lower wall 512.

In addition, in the display device 1 of the present embodiment, the plurality of first power supply components 42 whose temperature is likely to rise are thermally connected to the inner surface 512a of the lower wall 512 with no air therebetween. That is, air having high thermal insulation properties is not interposed between the first power supply components 42 and the lower wall 512. For this reason, heat of the first power supply components 42 can be efficiently transmitted to the lower wall 512. Therefore, temperature rise of the first power supply components 42 can be effectively curbed.

Moreover, in the display device 1 of the present embodiment, the plurality of second power supply components 43 are mounted on the second surface 41b of the board 41 constituting the power supply board 4. Further, the plurality of second power supply components 43 are thermally connected to an inner surface 511a of the upper wall 511 of the case 5 facing the second surface 41b of the board 41. Accordingly, heat of the plurality of power supply components 42 and 43 constituting the power supply board 4 can be released to the case 5 from both the first surface 41a side and the second surface 41b side of the board 41. Therefore, heat of the power supply components 42 and 43 can be more efficiently released.

In addition, in the display device 1 of the present embodiment, the heat radiator fins 52 are provided on the outer surfaces of the walls 51 (the upper wall 511 and the lower wall 512) of the case 5. Accordingly, heat transmitted to the walls 51 of the case 5 from the power supply components 42 and 43 can be efficiently dissipated to the air outside of the case 5 through the heat radiator fins 52 by causing air to flow along the outer surfaces of the walls 51 of the case 5 provided with the heat radiator fins 52. Therefore, the power supply components 42 and 43 can be efficiently cooled.

### Second Embodiment

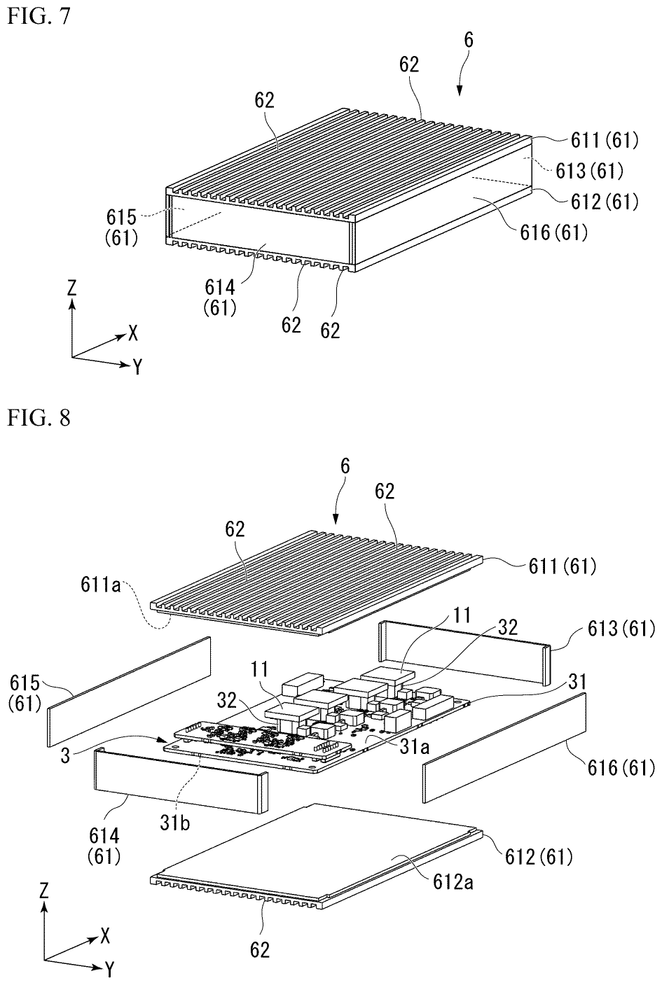

Next, a second embodiment of the present invention will be described with reference to FIGS. 7 to 9. In the second embodiment, the same reference signs are applied to constituent elements similar to those in the first embodiment, or the like, and description thereof will be omitted.

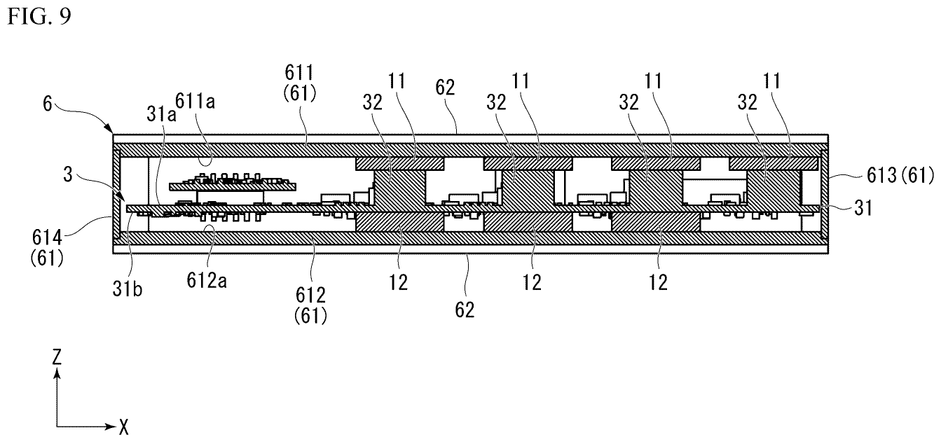

A display device of the second embodiment includes the light source 2, the power supply board 4, the projection lens 7, and the housing 8 similarly to the display device 1 of the first embodiment (FIGS. 1 and 2 refer to). In addition, the display device of the second embodiment includes the optical engine 3 (device component) shown in FIGS. 8 and 9, and a case 6 accommodating the optical engine 3.

The optical engine 3 has a board 31 (wiring board) and a plurality of heat generating component 32 mounted on the board 31. The heat generating component 32 of the optical engine 3 correspond to the optical components and the electronic components described in the first embodiment. The plurality of heat generating component 32 are mounted on only a first surface 31a (upper surface) of the board 31. In the second embodiment, the heat generating component 32 of the optical engine 3 or other components are not mounted on a second surface 31b of the board 31 facing a side opposite to the first surface 31a. In FIG. 9, heights of the plurality of heat generating component 32 mounted on the first surface 31a of the board 31 with respect to the first surface 31a are made uniform. However, for example, they may not be made uniform.

The case 6 shown in FIGS. 7 to 9 accommodates the foregoing optical engine 3 (device component) in a sealed state with respect to the outside or a state with a high sealing degree. Walls 61 of the case 6 are thermally connected to the heat generating component 32 of the optical engine 3.

Similar to the case 5 of the first embodiment, the case 6 of the second embodiment has a rectangular parallelepiped external appearance and has six flat plate-shaped walls 61 (an upper wall 611, a lower wall 612, a front wall 613, a rear wall 614, a left wall 615, and a right wall 616) which are directed forward, rearward, leftward, rightward, upward, and downward respectively. The X axis direction, the Y axis direction, and the Z axis direction indicated in FIGS. 7 to 9 respectively indicate the forward-rearward direction, the lateral direction, and the vertical direction. The six walls 61 each include a heat radiating part which releases heat of the heat generating component 32 outside of the case 6. Materials and assembly structures of the six walls 61 serving as heat radiating parts may be similar to those of the walls 51 of the case 5 in the first embodiment.

As shown in FIGS. 8 and 9, the upper wall 611 of the case 6 is disposed in a manner of facing the first surface 31a (upper surface) of the board 31 constituting the optical engine 3. Further, the plurality of heat generating component 32 mounted on the first surface 31a of the board 31 are thermally connected to an inner surface 611a of the upper wall 611. In the second embodiment, the plurality of heat generating component 32 are thermally connected to the upper wall 611 with no air therebetween. Hereinafter, this structure will be described.

The display device of the second embodiment includes a first thermal connection component 11. The first thermal connection component 11 fills a space between the heat generating component 32 and the inner surface 611a of the upper wall 611 and thermally connect the upper wall 611 and the heat generating component 32 to each other. When there is a need to electrically insulate the upper wall 611 (the case 6) and the heat generating component 32 from each other, the first thermal connection component 11 may have electrical insulation properties. For example, the first thermal connection component 11 may be a heat dissipation silicon sheet or a two-component hardened heat dissipation grease. In FIGS. 8 and 9, one first thermal connection component 11 is provided in each of the plurality of heat generating component 32. However, for example, only one may be provided for the plurality of heat generating component 32.

In addition, in the display device of the second embodiment, the lower wall 612 of the case 6 is disposed in a manner of facing the second surface 31b (lower surface) of the board 31 constituting the optical engine 3. Further, the second surface 31b of the board 31 is thermally connected to the lower wall 612 (different wall). In the second embodiment, the board 31 is thermally connected to the lower wall 612 with no air therebetween. Hereinafter, this structure will be described.

As shown in FIG. 9, the display device of the second embodiment includes a second thermal connection component 12. The second thermal connection component 12 fills a space between the second surface 31b of the board 31 and an inner surface 612a of the lower wall 612 and thermally connect the board 31 and the lower wall 612 to each other. Characteristics and concrete materials of the second thermal connection component 12 may be the same as those of the first thermal connection component 11.

The second thermal connection component 12 is provided in a region on the second surface 31b of the board 31 overlapping the heat generating component 32 in a thickness direction of the board 31. Accordingly, heat of the heat generating component 32 can also be efficiently transmitted to the lower wall 612. For example, the second thermal connection component 12 may be provided on the entire second surface 31b of the board 31.

As shown in FIGS. 8 and 9, respective inner surfaces of the front wall 613, the rear wall 614, the left wall 615, and the right wall 616 of the case 6 surround the board 31 constituting the optical engine 3 accommodated in the case 6. The respective inner surfaces of the front wall 613, the rear wall 614, the left wall 615, and the right wall 616 are disposed with an interval with respect to the plurality of heat generating component 32 mounted on the board 31. For this reason, the plurality of heat generating component 32 are thermally connected to the front wall 613, the rear wall 614, the left wall 615, and the right wall 616 through the air. For example, spaces between the heat generating component 32 and the front wall 613, the rear wall 614, the left wall 615, and the right wall 616 may also be filled with the thermal connection components 11 and 12 described above.

In the case 6 of the second embodiment, similar to the case 5 of the first embodiment, a plurality of heat radiator fins 62 are provided on the outer surfaces of the upper wall 611 and the lower wall 612 of the case 6. Shapes and the array of the heat radiator fins 62 are similar to those in the first embodiment.

According to the display device of the second embodiment, effects similar to those in the first embodiment are exhibited.

In addition, in the display device of the second embodiment, spaces between the heat generating component 32 and the inner surface 611a of the upper wall 611 are filled with the first thermal connection component 11 thermally connecting the upper wall 611 and the heat generating component 32 to each other. Accordingly, the first thermal connection component 11 can prevent a space from being formed between the heat generating component 32 and the inner surface 611a of the upper wall 611. That is, it is possible to curb or prevent interposition of air having high thermal insulation properties between the heat generating component 32 and the walls 61. Therefore, heat of the heat generating component 32 can be efficiently transmitted to the upper wall 611 of the case 6.

Moreover, in the display device of the second embodiment, the second surface 31b of the board 31 constituting the optical engine 3 is thermally connected to the lower wall 612 (a different wall 61) of the case 6 facing the second surface 31b. Accordingly, heat of the plurality of heat generating component 32 mounted on the board 31 can be released to the case 6 from both the first surface 31a side and the second surface 31b side of the board 31. Therefore, heat of the heat generating component 32 can be more efficiently released.

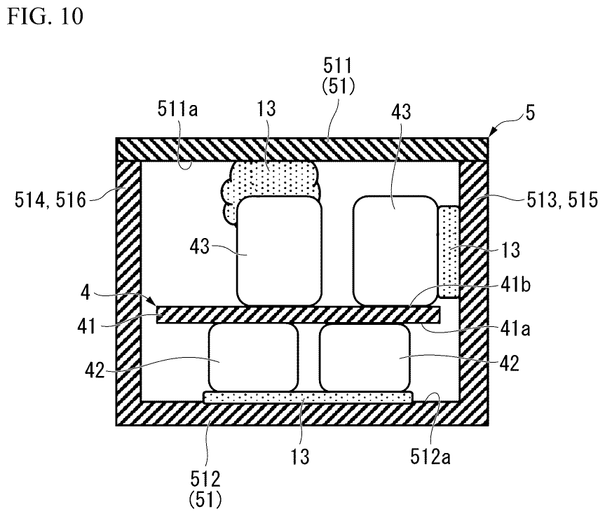

For example, the foregoing thermal connection components of the second embodiment may also be applied to the display device 1 of the first embodiment. In the display device 1 of the first embodiment, for example, as shown in FIG. 10, spaces between the first power supply components 42 mounted on the first surface 41a of the board 41 and the lower wall 512 of the case 5 may be filled with a thermal connection component 13. In addition, spaces between the second power supply components 43 mounted on the second surface 41b of the board 41 and the upper wall 511 of the case 5 may also be filled with the thermal connection component 13. Moreover, spaces between the power supply components 42 and 43 mounted on the board 41 (the second power supply components 43 in FIG. 10) and the side walls (the front wall 513, the rear wall 514, the left wall 515, and the right wall 516) of the case 5 may also be filled with the thermal connection component 13. In this case, effects similar to those in the foregoing second embodiment are exhibited.

Hereinabove, the embodiments of the present invention have been described. However, the present invention is not limited to the foregoing embodiments and can be suitably changed within a range not departing from the gist thereof. The present invention is not limited to projection-type display devices and may be applied to any display devices such as LCD displays, plasma displays, and organic electro-luminescence (organic EL) displays.

### REFERENCE SIGNS LIST

1 Display device
2 Light source
3 Optical engine (device component)
31 Board
31a First surface
31b Second surface
32 Heat generating component
4 Power supply board (device component)
41 Board
41a First surface
41b Second surface
42, 43 Power supply component (heat generating component)
5 Case
51 Wall
511a, 512a Inner surface
52 Heat dissipation fin
6 Case
61 Wall
611a, 612a Inner surface
62 Heat dissipation fin
7 Projection lens
11, 12, 13 Thermal connection component

What is claimed is:

1. A display device comprising:
a light source;
an optical engine configured to generate image light to be displayed on a display surface on the basis of light from the light source;
a power supply board configured to drive the light source and the optical engine; and
a case configured to accommodate a device component which comprises at least one of the optical engine and the power supply board,
wherein the case has a wall which include a heat radiating part that is thermally connected to a heat generating component included in the device component, to allow heat of the heat generating component to be released outside of the case, and
wherein the heat generating component is mounted on a first surface of a board included in the device component.

2. The display device according to claim 1,
wherein the device component includes a plurality of the heat generating components that are thermally connected to an inner surface of the wall facing the first surface.

3. The display device according to claim 2,
wherein a second surface of the board, which faces a side opposite to the first surface, is thermally connected to a different wall of the case, and the different wall faces the second surface.

4. The display device according to claim 1, further comprising:
a thermal connection component configured to fill a space between the heat generating component and the inner surface of the wall so as to thermally connect the heat generating component and the wall to each other.

5. The display device according to claim 1, further comprising:
a plurality of heat radiator fins on an outer surface of the wall.

6. The display device according to claim 5,
wherein the heat radiator fins are disposed on the outer surface of the wall facing at least the first surface of the board.

7. The display device according to claim 5, further comprising:
a fan configured to flow air outside the case for cooling the case,
wherein the fan is configured to cause air to flow in a direction in which the heat radiator fins extend along the outer surface of the wall.

8. The display device according to claim 1, further comprising:
a projection lens configured to magnify the image light.
